(19) United States
(12) Patent Application Publication
(10) Pub. No.: US 2026/0272202 A1
(43) Pub. Date: Sep. 17, 2026

(54) Aumano: Automatic Mail Notification System Using ESP-NOW Protocol

(71) Applicants: Alan Kazemian, Powder Springs, GA (US); Jane Kazemian, Powder Springs, GA (US); Joe Kazemian, Powder Springs, GA (US)

(72) Inventors: Alan Kazemian, Powder Springs, GA (US); Jane Kazemian, Powder Springs, GA (US); Joe Kazemian, Powder Springs, GA (US)

(21) Appl. No.: 19/080,883

(22) Filed: Mar. 16, 2025

(51) Int. Cl. A47G 29/122; H04Q 9/02

(52) U.S. Cl. CPC A47G 29/1225; H04Q 9/02; A47G 2029/1226; A47G 2029/1229; H04Q 2209/823; H04Q 2209/883

(57) ABSTRACT

The invention provides a wireless mailbox notification system utilizing an ESP32-based transmitter and receiver, designed to alert users when their mailbox is accessed. The transmitter, powered by a rechargeable lithium polymer battery, includes a mercury switch that detects tilting when the mailbox is opened. The system communicates using the low-power ESP-NOW protocol, sending a signal to a receiver equipped with a visual LED indicator. The receiver is powered by a wall outlet and visually signals the user when the mailbox has been accessed. With deep sleep functionality, the system conserves battery power, allowing for up to 4 years of operation on a single charge. The system provides a simple, energy-efficient solution for mailbox monitoring, offering enhanced convenience and peace of mind for users without requiring frequent battery replacements or network setups.

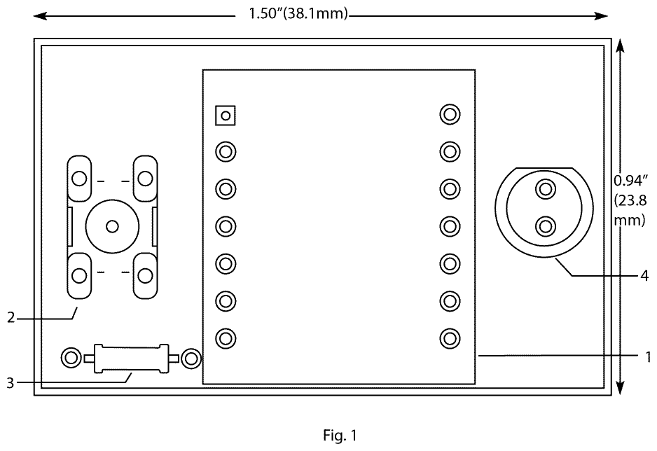

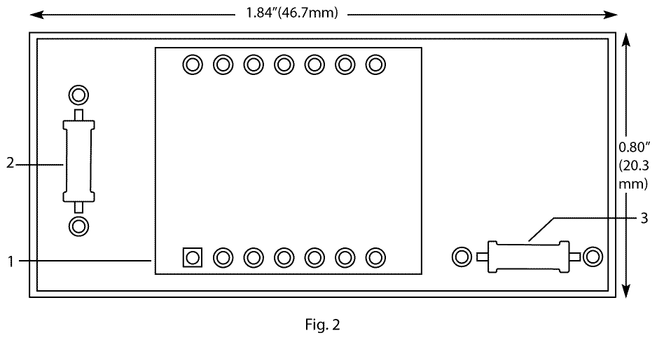

### DETAILED DESCRIPTION OF THE INVENTION

### Field of the Invention

This invention pertains to the field of wireless communication systems, specifically to notification systems for monitoring and alerting events such as mailbox status. M ore particularly, the invention relates to a mailbox notifier system utilizing an ESP32-based transmitter and receiver communication via the ESP-NOW protocol, coupled with a mercury switch to detect tilting and a battery-powered, self-contained setup. The invention leverages a deep sleep mode for the transmitter, allowing it to conserve power and extend the battery life, making it highly efficient for long-term, low-maintenance operation.

### BACKGROUND OF THE INVENTION

Mailbox notification systems are commonly used to alert individuals when mail or packages have been delivered to their mailbox. Existing systems often rely on wired connections or require frequent battery replacements due to high power consumption. These systems can be bulky and require continuous monitoring or manual resetting, leading to frequent maintenance and user inconvenience.

Prior art typically includes systems that use Wi-Fi, Bluetooth, or cellular networks to send notifications. While effective, these systems often consume considerable power, necessitating frequent charging or battery replacements. Additionally, many existing solutions lack a simple, low-maintenance setup and are not optimized for long-term use without constant attention.

The present invention solves these problems by utilizing a deep sleep feature of the ESP32 module, which allows the device to remain in a low-power state for nearly 24 hours a day. This enables the system to run for up to four years on a single 2000 mAh rechargeable battery, minimizing the need for battery replacements or frequent maintenance.

Additionally, the use of the ESP-NOW protocol for communication between the transmitter and receiver provides a simple, efficient, and wireless solution that eliminates the need for complex network setups or reliance on external infrastructure. The system also features a mercury switch for tilt detection, which ensures that notifications are sent only when the mailbox is tilted, providing accuracy in event detection.

In contrast to existing systems, the invention offers a self-contained, low-power, and easy-to-use solution that eliminates the need for frequent battery replacements or complex network setups, reducing maintenance requirements while providing reliable notifications.

### SUMMARY OF THE INVENTION

The present invention is a wireless mailbox notification system utilizing an ESP32-based transmitter and receiver, communicating via the ESP-NOW protocol. The transmitter, powered by a 3.7 2000 mAh rechargeable battery, is integrated with a mercury switch and pull-down resistor to detect the tilting of the mailbox. When the mailbox is opened, the tilt triggers the mercury switch, sending a signal to the receiver, which is connected to an LED indicator. The LED stays on for 8 hours after receiving the signal, unless manually reset, providing a clear visual notification.

The system is designed for low power consumption, utilizing the deep sleep function of the ESP32 to ensure the transmitter remains in a near-zero power state for 23 hours and 59 minutes each day. This enables the system to operate for up to 4 years on a single battery charge.

This invention offers a simple, reliable, and energy-efficient solution for mailbox notifications, requiring minimal maintenance while providing accurate alerts without the need for complex network setups or external infrastructure.

### DETAILED DESCRIPTION

The invention comprises two main components: a transmitter and a receiver. Both components are based on the ESP32-X aio modules, which are low-power microcontroller units with built-in Wi-Fi and Bluetooth capabilities. These modules communicate with each other using the ESP-NOW protocol, a power-efficient and direct communication method that eliminates the need for a centralized Wi-Fi network.

### Transmitter

The transmitter, as shown in the drawing, includes several key components, each labeled with a number pointing to specific parts. In the diagram:
A. Xaio ESP32 Module—This serves as the microcontroller and communication hub.
B. 10 kΩ Resistor—This functions as the pull-down resistor for the mercury switch.
C. Mercury Switch—This detects the tilting of the mailbox when it is opened, triggering the transmitter to send a signal to the receiver.

The transmitter is powered by a 3.7 2000 mAh rechargeable LiPo battery with a J ST connector. The battery provides sufficient power for long-term use and is rechargeable, ensuring the system remains operational without frequent battery replacements. The transmitter is designed to be energy-efficient by utilizing the deep sleep mode of the ESP32, which allows it to remain in an ultra-low power state for 23 hours and 59 minutes a day. During deep sleep, the current draw of the ESP32 is approximately 42 microamps, conserving power almost the entire day.

When the mailbox is opened, the mercury switch detects the tilt and closes the circuit, causing the input pin of the ESP32 to go high. This action wakes the ESP32 from deep sleep, activating the communication with the receiver via the ESP-NOW protocol. This power-saving feature helps extend the battery life to approximately 4 years on a single charge, as the transmitter is in deep sleep most of the time and only wakes up when triggered by the mercury switch.

A pull-down resistor (10 kΩ) is used in the circuit to ensure that the input pin of the ESP32 is pulled to ground when the mercury switch is in its default position (open). When the switch tilts and closes, it triggers a change in the circuit, allowing a voltage of 3.3 volts to be sent to the input pin of the ESP32. This signal is then used to activate the communication with the receiver via the ESP-NOW protocol.

### Receiver

The receiver, as depicted in the corresponding drawing, also contains several labeled components, each numbered accordingly:
A. Xaio ESP32 Module—This acts as the microcontroller and handles the reception of signals from the transmitter.
B. Tactile Pushbutton Switch—This allows the user to manually reset the system.
C. 10 kΩ Resistor—This is used in the receiver circuit.
D. 5 mm LED—This lights up when the receiver detects the signal from the transmitter.

Upon receiving the signal from the transmitter, the receiver activates an LED indicator that stays latched in the “on” position. The LED remains on for 8 hours, serving as a clear visual notification that the mailbox has been accessed. After 8 hours, the LED automatically turns off if not manually reset, providing a safety feature to prevent unnecessary power consumption.

The receiver's reset button allows the user to manually reset the system and turn off the LED indicator before the 8-hour timeout, should they wish to clear the notification sooner.

### System Overview

When the mailbox door is opened, the mercury switch in the transmitter is activated. This triggers the ESP32 transmitter to send a signal to the receiver via ESP-NOW. The receiver then lights up the LED, alerting the user. The system's power efficiency, combined with its long battery life, ensures that the mailbox notification system can be deployed without frequent maintenance.

### Features and Advantages

Low Power Consumption: The ESP32's deep sleep mode ensures that the transmitter remains in a low-power state for nearly the entire day, conserving energy and extending the battery life up to 4 years.

Simple Communication: ESP-NOW protocol allows the transmitter and receiver to communicate directly without requiring a Wi-Fi network, making the system simple and reliable.

Visual Notification: The LED provides a clear, visual indicator when the mailbox has been accessed. The 8-hour automatic shutoff feature ensures minimal power consumption.

Easy Reset Function: The reset button on the receiver gives users the ability to manually reset the system if needed.

Rechargeable Battery: The 3.7V 2000 mAh LiPo battery is rechargeable, reducing the need for battery replacements.

### Possible Variations

Solar Power Option: The system can be modified to include a small solar panel to recharge the battery, making it entirely self-sustaining. This is particularly useful for outdoor applications where the mailbox may be located in an area with plenty of sunlight.

Additional Sensors: The system can be expanded to include other types of sensors, such as light sensors or motion sensors, to detect additional events or conditions.

Remote Notification: While this invention is based on a simple local visual indicator, the system could be adapted to send remote notifications (e.g., via Wi-Fi or Bluetooth) to a user's smartphone for added convenience.

### Conclusion

This invention provides an efficient, reliable, and energy-conscious solution to mailbox notifications. The combination of a simple design, low power consumption, and effective communication between components makes it a practical and innovative solution for anyone who wants to monitor their mailbox's status with minimal maintenance.

1. A mailbox notification system comprising:
A wireless transmitter, the transmitter comprising an ESP32 X aio module with an onboard rechargeable lithium polymer battery;
A mailbox sensor, the sensor including a mercury switch configured to detect the tilting of the mailbox;
A pull-down resistor connected to the mercury switch, the resistor configured to complete or interrupt a circuit based on the position of the mailbox;
A receiver comprising an ESP32 module connected to a visual indicator, the receiver configured to receive a wireless signal from the transmitter via the ESP-NOW protocol, wherein the visual indicator is activated upon receiving the signal;
The wireless transmitter operates in a deep sleep mode with a current draw of approximately 42 microamps for extended battery life.

2. The mailbox notification system of claim 1, further comprising:
A buzzer integrated into the receiver to emit an audible sound when the signal is received, providing a notification for individuals who may have difficulty seeing the visual LED indicator;
A switch configured to toggle between the visual LED indicator and the buzzer, allowing the user to choose the preferred notification method. The switch allows the user to toggle between a visual-only notification or an audible-only notification, and can be set to activate both the buzzer and the LED for simultaneous notification if desired.

3. The mailbox notification system of claim 1, wherein the wireless transmitter operates in a deep sleep mode for at least 23 hours per day, consuming a current draw of approximately 42 microamps, thereby extending the operational battery life to a minimum of 4 years on a single 2000 mAh rechargeable lithium polymer battery.
